(19) United States
(12) Patent Application Publication
(10) Pub. No.: US 2006/0284342 A1
(43) Pub. Date: Dec. 21, 2006

(54) IMPRESSION TOOL

(75) Inventor: Tom Sanders, Moorpark, CA (US)

Correspondence Address: SHIMOKAJI & ASSOCIATES, P.C., 8911 RESEARCH DRIVE, IRVINE, CA, 92618, US

(73) Assignee: THE DUENDE GROUP, PASO ROBLES, CA (US)

(21) Appl. No.: 11/424,510

(22) Filed: Jun. 15, 2006

Related U.S. Application Data
(60) Provisional application No. 60/691,193, filed on Jun. 15, 2005.

(51) Int. Cl. B29C 41/00

(52) U.S. Cl. 264/299; 425/458

(57) ABSTRACT

An impression tool may be useful for patterning or creating an impression on the surface of an object. The impression tool may be comprised of a convex first end portion and second end portion affixed to a body. The ergonomics of the first end portion may facilitate easier handling of the tool by fitting snugly into the palm of the hand, as opposed to a flat surface. The convex second end portion may provide ease of use by allowing the tool to be rolled or rocked over a surface.

### CROSS-REFERENCE TO RELATED APPLICATION

The present application claims the benefit of U.S. Provisional Application Ser. No. 60/691,193, which was filed on Jun. 15, 2005, and is incorporated herein by reference.

### BACKGROUND OF THE INVENTION

The present invention generally relates to an impression tool and method for patterning or creating an impression on the surface of an object, and more specifically, to an impression tool, and method for using the same, having a convex first end portion and second end portion affixed to a body for patterning or creating an impression on the surface of a malleable surface.

Material stamping may be useful in the creation of patterns or textures in a malleable material, such as clay. These patterns or textures may serve an aesthetic purpose and/or a functional purpose, such as in the stamping of a company logo. Conventional impression tools may be bulky, heavy or may require special machinery.

U.S. Pat. No. 5,219,511, issued to Fennessy, Sr., describes a tool for forming an impression in a surface of a moldable material, such as concrete. The tool of the '511 patent requires a specific manufacture method to result in a multi-layer design. Moreover, the tool of the '511 patent is heavy, often weighing from 15 to 35 lbs.

U.S. Pat. No. 5,044,791, issued to Lawson, describes an impression tool having a marker head supported on one handle and an anvil supported on another handle. The marker head may be made of a plurality of rotatable disks, each having a plurality of print characters formed upon, thereby allowing the print characters to be imprinted on an object, such as a wire sheath, by manually pressing the two handles together. The impression tool of the '791 patent is limited to imprinting items that may fit between the marker head and the anvil and may not generally be used to imprint a surface without having access to the other side of the surface.

As can be seen, there is a need for an impression tool, and method for using the same, that is simple, portable and may provide adequate impression on the surface of a malleable material.

### SUMMARY OF THE INVENTION

In one aspect of the present invention, a tool comprises a body; a first end portion affixed to the body; a second end portion affixed to the body; wherein the first end portion includes an impression surface having a plurality of cavities and projections formed thereon to create at least one of an impression or a pattern upon an impressionable surface

In another aspect of the present invention, a tool comprises a first end portion configured to be held in a hand of a user; a second end portion affixed to the first end portion; wherein the second portion is configured to provide a rocking motion on an impressionable surface.

In yet another aspect of the present invention, a method of patterning an impressionable surface, comprises rocking a surface having a plurality of cavities and projections on the impressionable surface.

In a further aspect of the present invention, a method of patterning the surface of an object, comprises providing a tool having a surface comprised of a series of cavities and projections formed thereon; applying the surface of cavities and projections to the impressionable surface; and applying an ink or stain on the impressionable surface.

These and other features, aspects and advantages of the present invention will become better understood with reference to the following drawings, description and claims.

### BRIEF DESCRIPTION OF THE DRAWINGS

FIG. 1 is a perspective view of a tool according to the present invention;

FIG. 2 is a side elevational view of the tool shown in FIG. 1;

FIG. 3 is a side plan view of the tool shown in FIG. 1;

FIG. 4 is a bottom plan view of the tool shown in FIG. 1 showing a surface including a plurality of cavities and projections;

FIG. 5 is a perspective view of a tool according to another embodiment of the present invention;

FIG. 6 is a side plan view of the tool shown in FIG. 5;

FIG. 7 is a side plan view of the tool shown in FIG. 5 imprinting a corner area of a surface; and

FIG. 8 is a flow chart describing a method according to another embodiment of the present invention.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

Broadly, the present invention provides an apparatus and method for patterning or creating an impression on the surface of an object. The apparatus or impression tool may be comprised of a convex first end portion and second end portion affixed to a body. The ergonomics of the first end portion may facilitate easier handling of the tool by fitting snugly into the palm of the hand, as opposed to a flat surface. The convex second end portion may provide ease of use by allowing the tool to be rolled or rocked over a surface.

The present invention may be used to create patterns or impressions on a variety of surfaces, such as fiberboard, such as Balsa-Foam™ by American Foam Technologies, Inc., or clay and the like. The patterns and impressions can be made on malleable surfaces by applying sufficient pressure on the tool when the tool is applied to the surface. Likewise, the patterns and impressions can also be made by applying an ink or stain to the impression made by the tool.

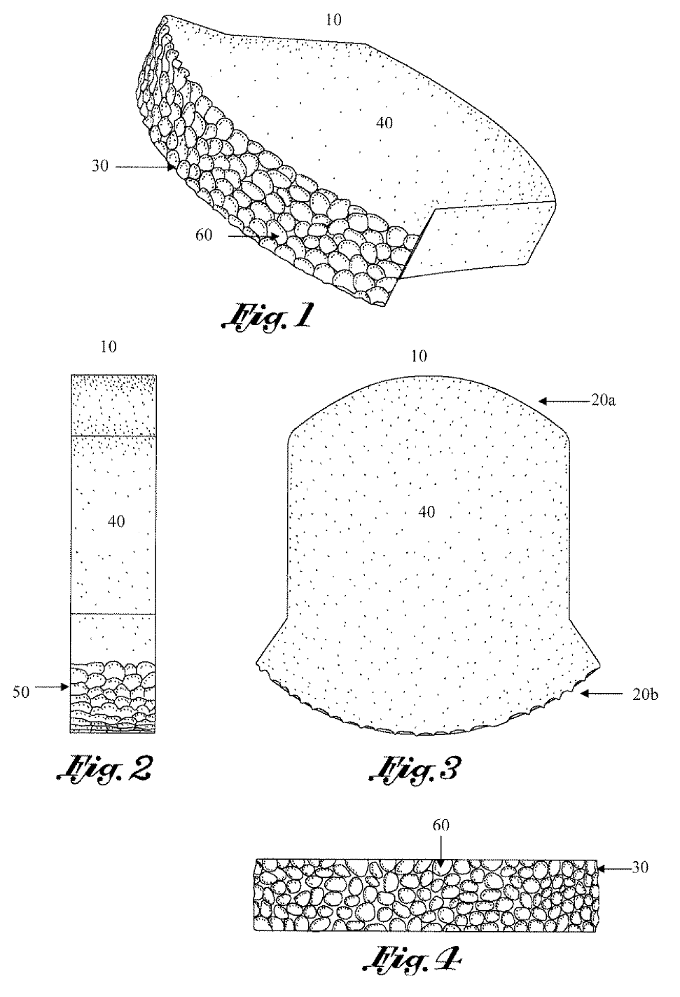

FIG. 1 is a perspective view and FIG. 4 is a bottom plan view of a tool 10. The body 40 of the tool 10 may include two end portions 20a and 20b. The end portions 20a and 20b may be affixed to the body 40 of the tool 10 by either forming the body 40 and the two end portions 20a, 20b as one integral component or by later attaching the two end portions 20a, 20b to the body 40.

A first surface 50 (see FIG. 2) of one end portion 20b may have a plurality of cavities 60 and projections 30 formed thereon, arranged in a defined spatial relationship. This spatial relationship may illustrate, but is not limited to, a predefined pattern, a company trademark or logo, or the like. The projections 30 and cavities 60 on the first surface 50 can create patterns or impressions on a second impressionable surface, such as Balsa Foam™ or clay, when the surface 50 is applied to the impressionable surface. The patterns or impressions can also be made by administering an ink or stain to the impressionable surface after impressing the projections 30 upon the impressionable surface. Moreover, a pattern may be formed by administering ink or stain to the cavities 60 and/or projections 30 and applying the tool 10 to the impressionable surface.

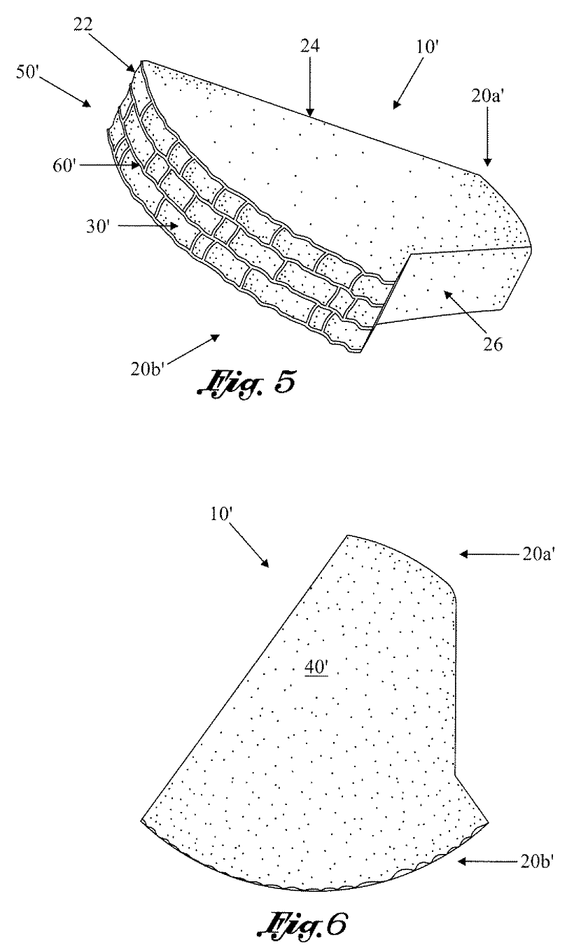

FIG. 2 is a side elevational view and FIG. 3 is a side plan view of a tool. The first end portion 20a may provide for an ergonomic shape which facilitates handling of the tool by fitting into the palm of the hand. The convex shape of the second end portion 20b allows the surface having a plurality of cavities and projections to roll or rock over other surfaces with ease. Likewise, the convex shape and density of the second end portion 20b may also enable pressure to be applied in small distances allowing the user to control rows of impressions.

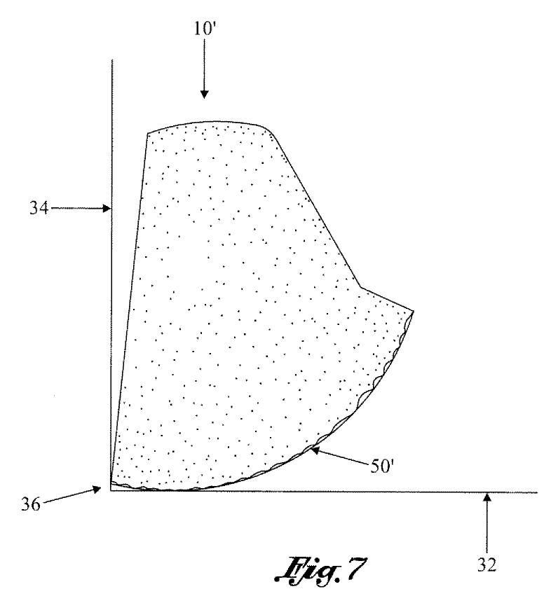

Referring now to FIGS. 5 and 6, there is shown an alternative embodiment of a tool 10′ according to another embodiment of the present invention. One side 24 of tool 10′ may be linear, forming an angle 22 with a first surface 50′ of one end portion 20b′. This angle 22 may be about 90 degrees or less. In one embodiment of the present invention, the angle 22 may be from about 70 to about 90 degrees. In another embodiment of the present invention, the angle 22 may be about 90 degrees.

Similar to the embodiment shown in FIGS. 1 through 4, this embodiment of the present invention may include cavities 60′ and projections 30′ on the surface 50′. The pattern formed by cavities 60′ and projections 30′ may be the same as in the previous embodiment (not shown), or may be an alternative pattern, as shown. Furthermore, one end portion 20a′ may provide for an ergonomic shape which facilitates handling of the tool by fitting into the palm of the hand. The convex shape of the end portion 20b′ allows the surface 50′ having a plurality of cavities 60′ and projections 30′ to roll or rock over other surfaces (such as impressionable surfaces, not shown) with ease. Likewise, the convex shape and density of the end portion 20b′ may also enable pressure to be applied in small distances allowing the user to control rows of impressions.

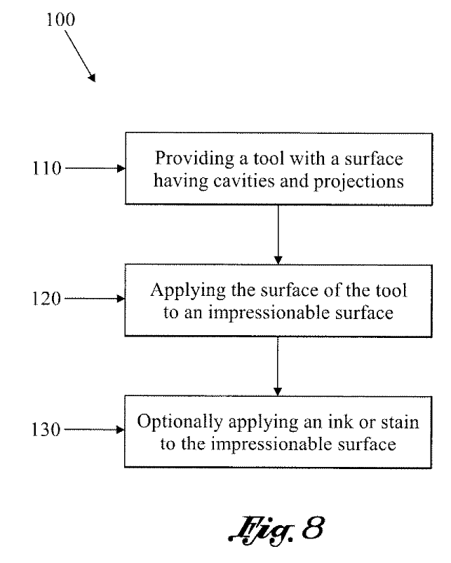

FIG. 7 shows a side plan view of how the tool 10′ may fit into a corner 36 formed between a side 34 and an impressionable surface 32. Surface 50′ of tool 10′ may then be capable of providing a pattern or impression on the impressionable surface 32 up to the point about where the side 34 meets the impressionable surface 32.

Referring now to FIGS. 5 through 7, the angle 22 on tool 10′ may be selected to be about equal to or less than an angle formed between the side 34 and the impressionable surface 32. This allows tool 10′ to fit into the corner 36 and provide a pattern or impression on substantially the entire area of impressionable surface 32.

Referring to FIG. 8, there is shown a method 100 according to another embodiment of the present invention. A step 110 may include providing a tool with a surface having cavities and projections. The surface may have a convex shape to allow the surface to rock or roll over an impressionable surface. A step 120 may include applying the surface of the tool to the impressionable surface. The amount of pressure applied to the surface with the tool may be chosen depending on both the desired impression and the impressionability of the impressionable surface. An optional step 130 may include applying an ink or stain to the impressionable surface. The ink or stain may be applied after the impression is made, or, alternatively, the ink or stain may be applied with the tool, thereby stamping a pattern on the impressionable surface based on a pattern of the cavities and projections.

It should be understood, of course, that the foregoing relates to preferred embodiments of the invention and that modifications may be made without departing from the spirit and scope of the invention as set forth in the following claims.

We claim:

1. A tool comprising:
a body;
a first end portion affixed to said body;
a second end portion affixed to said body;
wherein said first end portion includes an impression surface having a plurality of cavities and projections formed thereon to create at least one of an impression or a pattern upon an impressionable surface.

2. The tool according to claim 1, wherein said second end portion is configured to be held in a hand of a user.

3. The tool according to claim 1, wherein said first end portion has a convex shape to be capable of providing a rocking motion of said impression surface upon said impressionable surface.

4. The tool according to claim 3, wherein at least one side of said body is linear, forming an angle with said first end portion of about 90 degrees or less, thereby allowing said impression surface to contact an inside corner area.

5. The tool according to claim 1, wherein said impression is made by applying pressure against said impressionable surface with said first end portion.

6. The tool according to claim 1, wherein said pattern is made by applying an ink or staining material to said impression surface.

7. The tool according to claim 1, wherein said impressionable surface is a malleable material.

8. The tool according to claim 8, wherein said malleable material is selected from the group consisting of clay, fiberboard and foam.

9. A tool comprising:
a first end portion configured to be held in a hand of a user;
a second end portion opposite to said first end portion;
wherein said second end portion is configured to provide a rocking motion on an impressionable surface.

10. The tool according to claim 9, wherein the second end portion has a convex shape.

11. The tool according to claim 9, further comprising a plurality of cavities and projections formed on said second end portion.

12. The tool according to claim 9, wherein at least one side of said body is linear, forming an angle with said first end portion of about 90 degrees or less, thereby allowing said impression surface to contact an inside corner area.

13. The tool according to claim 9, wherein said impression is made by applying pressure against said impressionable surface with said first end portion.

14. The tool according to claim 9, wherein said pattern is made by applying an ink or staining material to said impression surface.

15. A method of patterning an impressionable surface, comprising:
rocking a surface having a plurality of cavities and projections on said impressionable surface.

16. The method according to claim 15, further comprising applying an ink or stain on said impressionable surface.

17. The method according to claim 16, wherein said ink or stain is applied to said surface prior to said step of rocking said surface, thereby imparting a pattern onto said impressionable surface.

18. A method of patterning the surface of an object, comprising:
providing a tool having a surface comprised of a series of cavities and projections formed thereon;
applying said surface of cavities and projections to said impressionable surface;
applying an ink or stain on said impressionable surface.

19. The method according to claim 18, further comprising forming said surface in a convex shape.

20. The method according to claim 19, further comprising rocking said surface said impressionable surface.
